(19) United States
(12) Patent Application Publication
(10) Pub. No.: US 2023/0301403 A1
(43) Pub. Date: Sep. 28, 2023

(54) INSERTION TONGUE FOR A BELT BUCKLE

(71) Applicant: Marion Mohr, Bonn (DE)

(72) Inventor: Marion Mohr, Bonn (DE)

(21) Appl. No.: 18/125,438

(22) Filed: Mar. 23, 2023

(30) Foreign Application Priority Data
Mar. 25, 2022 (DE) 10 2022 107 170.7

(51) Int. Cl. A44B 11/25

(52) U.S. Cl. CPC A44B 11/2553; A44B 11/2561; A61G 1/044

(57) ABSTRACT

An insertion tongue for a belt retaining system in patient transport displays a tongue plate with a belt duct and a belt surround bar opposite the belt duct, around which, in use, a belt is placed and which is displaceably supported transversely to its longitudinal direction. The belt surround bar has two bars parallel to one another, with one or more rotatable rollers or pulleys being arranged on the bar which is outer in relation to the insertion tongue.

### CROSS REFERENCE TO RELATED APPLICATION

This application claims priority to German Application Number 10 2022 107 170.7 filed Mar. 25, 2022 and titled “Insertion Tongue For A Belt Buckle,” the entirety of which is incorporated herein by reference.

### TECHNICAL FIELD

This invention generally relates to an insertion tongue for a belt buckle, and more particularly to an insertion tongue for a belt retaining system in patient transport.

### BACKGROUND

An insertion tongue for a belt retaining system is known from the international application WO 2014/127910 A1, where the retaining belt surrounds a recess in the insertion tongue and a movably mounted bar. During a sudden tractive force exerted towards the belt, e.g., during an accident, the movably mounted bar is supposed to be displaced towards the recess and thus prevent the belt from slipping through by massively narrowing the recess and consequently clamping the belt between the bar and the edge of the recess. This known insertion tongue for a belt buckle is partly depicted as a cross section in FIG. 1.

In the field of patient transport, belts as described in the application above have to be coated such that they are easy to clean and disinfect. Additionally, particularly in the field of ambulance transport it is important, that an individual adjusting of the belt depending on the patient and on the circumstances of the particular case is simply and quickly feasible. Experience has shown that the conventional system does not meet these challenges since it is too time consuming and cumbersome to adjust the belt setting.

Another insertion tongue is further known from the German utility model DE 20 2018 106 550 of the applicant. Nevertheless, experience has shown that the known insertion tongue does not yet convince concerning all requirements, especially concerning the durability and ease of motion.

However, each of these devices, and their related methods, has limitations on its effectiveness, and none provide the various combination of benefits my insertion tongue for a belt retaining system in patient transport, especially when it comes to being able to more safely, and with less physical effort, and more ergonomically, fasten, tighten and/or use my invention. Thus, there is a need to address one or more of the deficiencies in the art to better aid in achieving more desirable requirements and avoiding negative ones, for a belt retaining system like mine, especially when used in patient transport, and preferably in a way that is more consistent and reliable for such a belt retaining system.

### SUMMARY

The present invention aims at a reduction of, or even overcoming these problems. In order to do so, the invention proposes an insertion tongue according to claim 1, as well as the belt retaining system for patient transport according to claim 6.

The insertion tongue for a belt buckle according to the present invention simplifies the adjustment of the position of the insertion tongue in such a rate that it can be performed rapidly and without any obstacles.

Further, there is provided an insertion tongue for a belt retaining system for patient transport. The insertion tongue includes a tongue plate with a belt duct and a belt surround bar opposite the belt duct, around which, in use, a belt is placed and which is displaceably supported transversely to its longitudinal direction. The belt surround bar has two bars parallel to one another, with one or more rotatable rollers or pulleys being arranged on the bar which is outer in relation to the insertion tongue and forms the outer bar.

Other aspects of the invention will subsequently be described further based on the drawings. The invention is, however, not limited to these aspects, and the skilled person will be aware of suitable modifications.

### BRIEF DESCRIPTION OF THE DRAWINGS

The invention may be more completely understood in consideration of the following detailed description of various features of the invention in connection with the accompanying drawings, in which:

FIG. 1 is a cross-section view through a conventional insertion tongue for a belt buckle;

FIG. 2a-c is top view, profile view, and front view of an insertion tongue for a belt buckle according to the present invention; and,

FIG. 3 is a cross-section view of a belt roller of the insertion tongue seen in

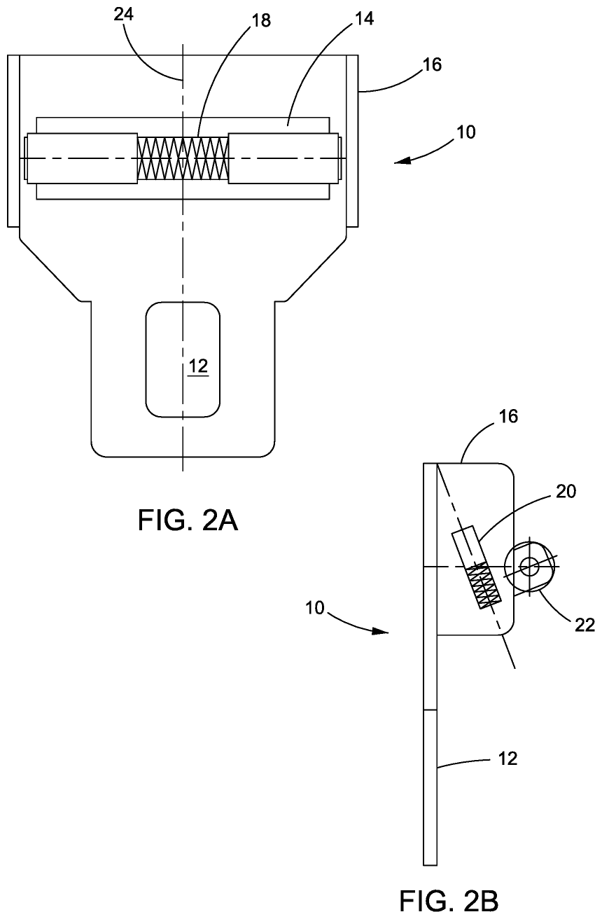

FIGS. 2a-c.

The drawings show some but not all embodiments. The elements depicted in the drawings are illustrative and not necessarily to scale, and the same (or similar) reference numbers denote the same (or similar) features throughout the drawings, though all the same (or similar) features are not always separately numbered to help avoid over numbering and obscuring what the drawings are disclosing.

### DETAILED DESCRIPTION

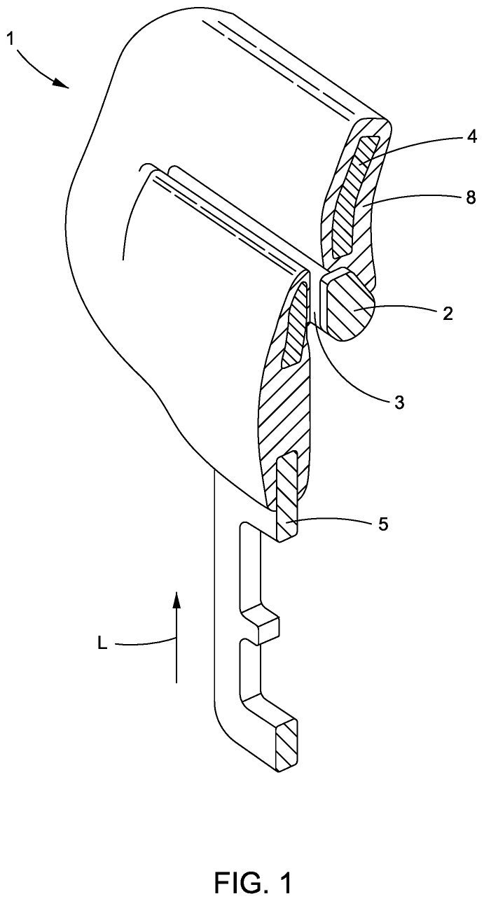

In FIG. 1, a cross-section through a conventional insertion tongue 1 for a belt buckle is shown. Direction L is the direction that the force acts into in the securing situation. A belt surround bar 2 features a surface 3 being in contact with the belt. The parts 4 and 5 of the insertion tongue are metallic, and the part 8 is made of plastic. The bar 2 is movable at both ends.

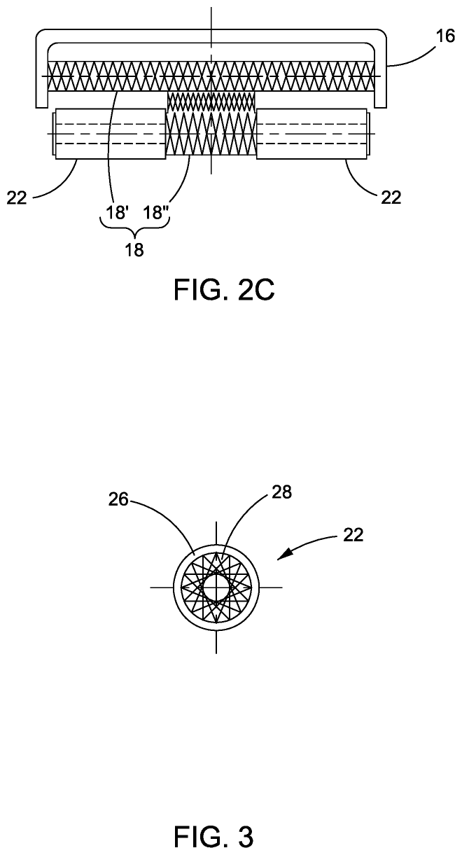

FIG. 2a shows a top view of an insertion tongue for a belt buckle 10 according to the present disclosure. The insertion tongue itself features a fist belt duct 14 and a buckle recess 12 for a hook to grasp into, the hook 12 being part of the complementary belt buckle (not shown). There are perpendicularly arranged lateral sections 16 provided, where ducts 20 for the belt surround bar 18 are located, as shown in the profile diagram FIG. 2b. These ducts are formed at an angle to the insertion tongue. Unlike the state of the art according to FIG. 1, the belt surround bar 18 in this embodiment is H-shaped by means of an outer bar 18″, relative to the insertion tongue, bearing two rollers 22 disposed laterally at its outer ends, being mounted on an inner bar 18′, relative to the insertion tongue, being supported in the ducts 20. In this embodiment, the connection between the two bars 18′ and 18″ is formed centrally in lateral direction, for example by welding. The rollers 22 are shown in cross-section in FIG. 3 and respectively feature a rubber coated plastic pipe, for example, rubberized surface 26 surrounding plastic tube 28. The materials may differ, depending on the belt material and use case. The roller axes can be supported at the center section of the bar.

In an alternative embodiment there is only one roller designated, preferably centred in lateral direction, the roller being supported in lateral bar sections, where the lateral bar sections in turn are respectively attached to the inner bar, relative to the insertion tongue. In this case, the bearing must be designed in such a way that the roller can be inserted into it for assembly or replacement. In addition, the axis of the roller for this purpose can, e.g., be telescopic. In general, the insertion tongue according to the present invention is formed mirror symmetric to the center plane 24.

Insertion tongues for a belt buckle according to the present disclosure greatly simplify shifting of the insertion tongue along the belt in order to adjust the belt length to the respective patient, such that this setting can be carried out rapidly and simply in case of operation, since the conventionally occurring slide friction is replaced by the essentially smaller rolling friction. However, the clamping effect in a trigger event is not hampered, which is important in terms of safety.

The insertion tongues according to the present disclosure when in usage naturally form a part of a belt retaining system in patient transport. To this belongs a belt buckle being complementary to the insertion tongue. Further the belt surrounds the belt surround bar and either the single belt duct of the bar (first insertion tongue version) or two belt ducts (second version). Since the belt surround bar is supported such that it can be moved transversely to its longitudinal axis, the belt can be self-locked by tension onto both belt ends in the event of an accident: For this purpose, the belt surround bar can be moved along the grooves arranged in the side wings of the insertion tongue. When applying a sudden strong tension onto a belt surrounding the belt surround bar, the bar slips back in the grooves and hence, since the grooves are designed inclined, closer to the edges of the belt duct, whereby a clamp force onto the belt is induced preventing the belt from slipping through the belt duct.

According to the present disclosure, the belt surround bar features a bar being closer to the tongue plate and a bar being further from the tongue plate, both being firmly connected to each other, for example by welding. The bar being further from the tongue plate in turn has one or two outer rollers or pulleys centered in relation to a plane of symmetry. In a first variant, two outer rollers or pulleys are mounted on a central bar, “outer” being understood here in a lateral sense; in a second variant, a roller or pulley arranged centrally with respect to the plane of symmetry is held between two laterally outer parts of the compared to the tongue plate outer belt surround bar. Instead of one, there can also be several rollers and/or pulleys arranged on a common axis, being mounted on the two laterally outer bar parts.

In both variants, the rotatability of the rollers or rather the pulleys facilitates rapid adjustment of the belt to the prevailing conditions. At the same time, however, it is still ensured that the belt surround bar, when a jerky force is applied on the belt loop wrapped around it, shifts in its holder towards the recess in the tongue plate into a clamping position and thus prevents the belt from slipping through the recess. Incidentally, the rollers or pulleys may be coated to reduce slippage or/and surrounded by a polymeric material, but this is not necessary due to the rotatability of the rollers or pulleys. In one embodiment, the rollers or pulleys are, on the contrary, rubber coated for increased grip (friction).

The foregoing embodiments explain the present invention by way of example only. Those skilled in the art will recognize that numerous modifications, additions and substitutions are possible without departing from the scope of protection of the invention disclosed in the following claims.

For example, the belt is preferably formed from a coated fabric material, in particular coated with a thermoplastic polymer material. This is advantageous in order to ensure sufficient tensile strength and, at the same time, ensures suitability for disinfection. However, it is also possible to instead provide a homogeneous belt material and/or a different coating or none at all.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The present invention includes the description, examples, embodiments, aspects and drawings disclosed; but it is not limited to such description, examples, embodiments, aspects or drawings. As briefly described above, the reader should assume that features of one disclosed embodiment or aspect can also be applied to all other disclosed embodiments and aspects, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the applicable mechanical tools arts, and all such modifications and other embodiments are intended and deemed to be within the scope of the present invention.

What is claimed is:

1. An insertion tongue for a belt retaining system for patient transport, comprising:
a tongue plate with a belt duct; and
a belt surround bar opposite the belt duct, around which, in use, a belt is placed and which is displaceably supported transversely to its longitudinal direction, the belt surround bar having two bars parallel to one another, with one or more rotatable rollers or pulleys being arranged on the bar which is outer in relation to the insertion tongue and forms the outer bar.

2. The insertion tongue according to claim 1, wherein on both sides of the outer bar, respectively, a roller or pulley is mounted rotatably on a bearing attached to the outer bar, the outer bar being centered in lateral direction and arranged outwardly in relation to the insertion tongue.

3. The insertion tongue according to claim 1, wherein a roller(s) or a pulley(s) being centered in lateral direction is mounted rotatably between two bar parts which are arranged outwardly in relation to the insertion tongue.

4. The insertion tongue according to claim 1, wherein the belt surround bar is designed and arranged to block the rotation of the roller(s) or the pulley(s) when a jerking force is applied by the belt loop wrapped around it, in use.

5. The insertion tongue according to claim 4, further comprising a receiving part being complementary to the insertion tongue and having a latching apparatus, together forming a locking mechanism.

6. A belt retaining system for patient transport, comprising the insertion tongue according to claim 1, and a retainer belt.

7. The belt retaining system according to claim 6, wherein the belt is formed substantially of a fabric material.

8. The belt retaining system according to claim 6, wherein the belt is coated with a polymeric material.

9. The belt retaining system according to claim 8, wherein the polymeric material is thermoplastic.

10. The belt retaining system according to claim 9, wherein the thermoplastic polymeric material consists mainly or entirely of polyvinyl chloride (PVC).

11. The insertion tongue according to claim 2, wherein the belt surround bar is designed and arranged to block the rotation of the roller(s) or pulley(s) when a jerking force is applied by the belt loop wrapped around it, in use.

12. The insertion tongue according to claim 11, further comprising a receiving part being complementary to the insertion tongue and having a latching apparatus, together forming a locking mechanism.

13. The insertion tongue according to claim 3, wherein the belt surround bar is designed and arranged to block the rotation of the roller(s) or pulley(s) when a jerking force is applied by the belt loop wrapped around it, in use.

14. The insertion tongue according to claim 13, further comprising a receiving part being complementary to the insertion tongue and having a latching apparatus, together forming a locking mechanism.

15. The belt retaining system according to claim 7, wherein the belt is coated with a polymeric material.

16. The belt retaining system according to claim 15, wherein the polymeric material is thermoplastic.

17. The belt retaining system according to claim 16, wherein the thermoplastic polymeric material consists mainly or entirely of polyvinyl chloride (PVC).
